(19) United States
(12) Patent Application Publication
(10) Pub. No.: US 2026/0067567 A1
(43) Pub. Date: Mar. 5, 2026

(54) METHOD FOR OPERATING A CAMERA SYSTEM AND CAMERA SYSTEM

(71) Applicant: Robert Bosch GmbH, Stuttgart (DE)

(72) Inventors: Peter Seitz, Renningen (DE); Robin Schneider, Ehningen (DE)

(21) Appl. No.: 19/303,604

(22) Filed: Aug. 19, 2025

(30) Foreign Application Priority Data
Aug. 29, 2024 (DE) 10 2024 208 226.0

(51) Int. Cl. H04N 23/661; H04N 23/60; H04N 23/667

(52) U.S. Cl. CPC H04N 23/661; H04N 23/64; H04N 23/667

(57) ABSTRACT

A method for operating a camera system including a camera head and a control unit, which are connected to one another by means of a high-frequency channel. The method includes: detecting at least one physical parameter in the camera head and outputting it as a first signal using a detector unit; converting the first signal into a low-frequency signal within a carrier frequency range using a carrier frequency modulator; transmitting the low-frequency signal to the control unit by means of a first passive coupler via the high-frequency channel; receiving the low-frequency signal using a second passive coupler in the control unit; demodulating the low-frequency signal using an envelope detector; comparing the demodulated signal with at least one reference value using a threshold circuit in order to obtain a comparison result; and outputting a control signal according to the comparison result.

### FIELD

The present invention relates to a method for operating a camera system and to a camera system.

### BACKGROUND INFORMATION

German Patent No. DE 10 2024 201 747 describes an image capture device having an optical unit that is designed to direct light onto a capture region, a sensor carrier arranged at least partially in the capture region, an image sensor for capturing an image using the light directed onto the capture region, wherein the image sensor is arranged on the sensor carrier and in the capture region, and at least one detector unit for detecting at least one property of the light directed onto the capture region, wherein the at least one detector unit is arranged adjacent to the image sensor on the sensor carrier and in the capture region.

### SUMMARY

The present invention relates to a method for operating a camera system comprising a camera head and a control unit, which are connected to one another by means of a high-frequency channel. According to an example embodiment of the present invention, the method includes the following steps: detecting at least one physical parameter in the camera head and outputting it as a first signal by means of a detector unit; converting the first signal into a low-frequency signal within a carrier frequency range by means of a carrier frequency modulator; transmitting the low-frequency signal to the control unit via the high-frequency channel by means of a first passive coupler; receiving the low-frequency signal by means of a second passive coupler in the control unit; demodulating the low-frequency signal by means of an envelope detector; comparing the demodulated signal with at least one reference value by means of a threshold circuit in order to obtain a comparison result; and outputting a control signal according to the comparison result.

According to an example embodiment of the present invention, the method according to the present invention can run in a camera system in which the camera head and the control unit are formed separately from one another in different structural units. In addition to the units necessary for the method of the present invention, the camera head and the control unit comprise additional units. In particular, the camera head further comprises an image sensor, which is designed to detect light incident from a surrounding area of the camera system as image data. Furthermore, the camera head comprises in particular a serializer, which is designed to convert the image data into a serial data format and to transmit them to the control unit via the high-frequency channel. The camera head further comprises, in particular, a PODL filter. PODL stands for Power-Over-Dataline. A PODL filter is in particular designed to apply the image data to the high-frequency channel and decouple them again. The control unit further comprises, in particular, a deserializer, which is designed to deserialize image data transmitted via the high-frequency channel and to transmit them to an image signal processor, which the control unit further comprises in particular. The control unit further comprises, in particular, a PODL filter.

A camera system in which the method presented here runs can be used, for example, in a vehicle. A vehicle can be understood as, for example, a car, a truck or a commercial vehicle. The camera system can be used, for example, for driver assistance systems.

Alternatively, the camera system can also be used in other fields. The high-frequency channel can also be called a high-speed video data channel or SerDes channel, where Ser stands for serializer and Des for deserializer. Such a high-frequency channel is used in an active state of the camera system in particular to transmit image data from the camera head to the control unit. The high-frequency channel can also be used to power the camera system.

A physical parameter in the camera head can be a property of light incident in the camera head from the surrounding area of the camera system. A corresponding property can be, for example, a brightness value, a spectral composition and additionally or alternatively a difference signal of the incident light from the surrounding area. The incident light from the surrounding area can be detected, for example, by means of an image sensor of the camera head. In this case, the image sensor of the camera head can serve as the detector unit for detecting the at least one physical parameter. The incident light from the surrounding area can alternatively be detected by means of a separately designed detector unit. Such a separately designed detector unit can, for example, be arranged adjacent to the image sensor on a sensor carrier of the camera head.

A physical parameter in the camera head can be a temperature in the camera head. The detector unit can in particular be a temperature sensor.

Converting the first signal into a low-frequency signal can be understood in such a way that the first signal is modulated onto a carrier frequency. The carrier frequency modulator can be viewed as a tone generator. The carrier frequency modulator can, for example, be designed as a controllable oscillator. The low-frequency signal comprises, in particular, a carrier frequency in the range of a few kilohertz to a few megahertz. The carrier frequency range lies in particular in a range of a few kilohertz to a few megahertz.

The envelope detector is designed in particular to detect an envelope of the low-frequency signal. An envelope is a curve that represents an amplitude of a signal over time.

In particular, at least one reference value is stored in the threshold circuit. The comparison result can advantageously show a brightness value being exceeded or not being met, a change in a spectral composition of ambient light and additionally or alternatively a change in difference signals, for example due to a change in the environment of the camera system due to an object moving into or out of a field of view of the camera system. The comparison result can advantageously show for example a reference value for a temperature in the camera head being exceeded or not being met.

According to an example embodiment of the present invention, if the demodulated signal exceeds or does not meet a stored reference value, this can serve as a start for a subsequent action. For example, a control signal can be output for switching on or off an image sensor of the camera head. For example, a control signal can be output for switching on or off a temperature control unit. The temperature control unit is designed to change a temperature at or in the camera head.

Advantageously, according to an example embodiment of the present invention, the method presented here can create a possibility to implement additional functions within a camera system in a cost-effective and simple manner. In particular, this creates a possibility of using a return channel via the existing high-frequency channel to the camera head. The high-frequency channel can be used for a second purpose, in particular in a switched-off state of the camera head. Here, the second use can be understood as the transmission of the low-frequency signal. Advantageously, the high-frequency transmission path is not disturbed in the active state. The method can advantageously also take place if an image sensor or a serializer of the camera head are not currently in operation, i.e., are currently in a so-called deep-sleep mode. Such a deep-sleep mode may occur, for example, during vehicle idle periods. The method presented here makes it possible, for example, to detect changes in the vehicle's surrounding area by means of the detector unit when the camera head is in a resting state and, for example, to output a wake-up signal for the camera head as a control signal.

When carrying out the method of the present invention described here, significantly lower power consumption can be achieved. The method can advantageously take place with very low energy consumption of the camera system. The energy requirements of the Camera system and in particular of the camera head can be significantly reduced for operating states in which continuous image transmission is not required. This significantly increases the operating time, in particular for battery-powered systems such as vehicles.

In addition, the method of the present invention can be implemented in camera systems that already use a high-frequency channel, wherein the implementation is independent of the type of production of the high-frequency channel or a protocol for transmission via the high-frequency channel.

In an advantageous embodiment of the present invention, the carrier frequency range differs from a frequency range for transmitting image data from an image sensor of the camera head. In other words, the transmission of the low-frequency signal takes place in a frequency range in which no transmission takes place from a serializer of the camera head to a deserializer of the control unit. The advantage of this embodiment is that noise with the transmission of image data from the camera head via the high-frequency channel to the control unit can be avoided. A load on the high-frequency channel can be avoided.

In an advantageous embodiment of the present invention, the low-frequency signal is designed to be sinusoidal. The advantage of this embodiment is that it makes precise modulation and demodulation possible. This results in reliable transmission with less noise and interference compared to other signal forms.

In an advantageous embodiment of the present invention, the method comprises the further step of filtering the received low-frequency signal by means of a bandpass filter. The advantage of this embodiment is that frequency ranges outside the carrier frequency range can be masked out. This significantly increases the accuracy and reliability of the method.

In an advantageous embodiment of the present invention, the method comprises the further step of controlling an image sensor of the camera head in order to put the image sensor into an activated or deactivated state according to the comparison result. Here, the output control signal is transmitted in particular from the control unit to the camera head. The control signal can also be referred to as a wake-up signal when putting the image sensor into an activated state. Thus, an on or off condition for the image sensor can be advantageously defined. Advantageously, the image sensor can be put into a resting state or an active state according to the comparison result. In addition, the image sensor can be left in a current operating state according to the comparison result. This can be the case, for example, if the demodulated signal does not fail to meet or does not exceed a reference value.

In an advantageous embodiment of the present invention, the method comprises the further step of controlling a unit that is designed to change at least one physical parameter of the camera head. Such a unit can, for example, be a temperature control unit, which is designed to change a temperature at or in the camera head. If, for example, when comparing the demodulated signal with a reference value, a comparison result is obtained which indicates that the temperature of the camera head has been exceeded, the temperature control unit can advantageously be controlled in such a way that the temperature at or in the camera head is reduced.

In an advantageous embodiment of the present invention, the control signal is additionally output to a sensor unit outside the Camera system. In this way, a further sensor unit, e.g. one installed in a vehicle, such as a camera, can also be advantageously activated. This makes it easy for further sensor units to also receive a wake-up signal. This can be helpful, for example, if initially only the camera system detects changes in the vehicle's surrounding area, e.g. due to a specific arrangement in a vehicle. This detection can then be passed on to further sensor units arranged elsewhere in the vehicle. These can then, e.g., advantageously transition from a deep-sleep mode to an active state early on.

The present invention further relates to a camera system comprising a camera head and a control unit, which are connected to one another by means of a high-frequency channel. Here, according to an example embodiment of the present invention, the camera head comprises a detector unit, which is designed to detect at least one physical parameter of the camera head and output it as a first signal; a carrier frequency modulator, which is designed to convert the first signal into a low-frequency signal; and a first passive coupler, which is designed to transmit the low-frequency signal to the control unit via the high-frequency channel. The control unit comprises a second passive coupler, which is designed to receive the low-frequency signal; an envelope detector, which is designed to demodulate the low-frequency signal; and a threshold circuit, which is designed to compare the demodulated signal with at least one reference value, obtain a comparison result and output a control signal.

In an advantageous embodiment of the present invention, the first and/or the second passive coupler is/are designed as a directional coupler, as a high-impedance resistive coupling and/or as a resistor. The advantage of this embodiment is that it enables reliable and precise transmission of the low-frequency signal via the high-frequency channel. A directional coupler can reduce unwanted feedback. A high-impedance resistive coupling can reduce signal loss and interference. By using a resistor, impedance can be adjusted, which can increase the accuracy and reliability of the transmission.

In an advantageous embodiment of the present invention, the control unit further comprises a bandpass filter. The advantage of this embodiment is that frequencies outside the carrier frequency range can be masked out.

The camera system of the present invention presented here can further be designed in such a way that the camera head is supplied with energy in the form of direct current. The image sensor and circuits for generating a control signal can also be supplied in the form of direct current. Alternatively, the camera head comprises a capacitor or accumulator in which energy can be stored. Such a capacitor or accumulator can be filled with energy during normal operation of the camera system, which energy can supply the detector unit in sleep mode, for example.

It is self-evident that the features mentioned above and those still to be explained below can be used not only in the combination specified in each case but also in other combinations or alone, without departing from the scope of the present invention.

### BRIEF DESCRIPTION OF THE DRAWINGS

Exemplary embodiments of the present invention are explained in more detail below with reference to the figures. Identical reference signs in the figures refer to identical or similarly acting elements.

FIG. 1 shows an exemplary embodiment of a method for operating a camera system, according to the present invention.

FIG. 2 shows an exemplary embodiment of a camera system, according to the present invention.

### DETAILED DESCRIPTION OF EXAMPLE EMBODIMENTS

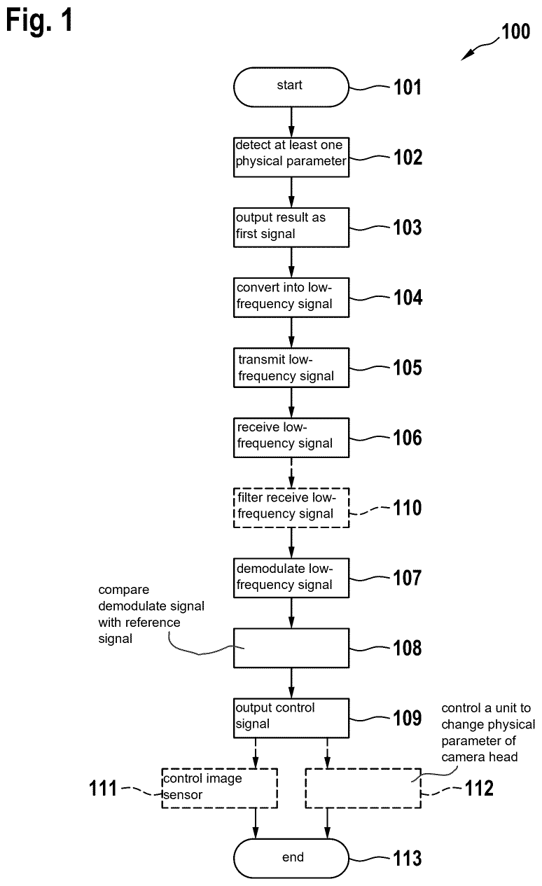

FIG. 1 shows an exemplary embodiment of a method 100 for operating a camera system. Here, the camera system comprises a camera head and a control unit, which are connected to one another by means of a high-frequency channel. The method 100 starts in step 101. In step 102, at least one physical parameter in the camera head is detected by means of a detector unit. In step 103, the result of the detection 102 is output as a first signal from the detector unit. In step 104, the first signal is converted into a low-frequency signal within a carrier frequency range by means of a carrier frequency modulator. In step 105, the low-frequency signal is transmitted to the control unit via the high-frequency channel by means of a first passive coupler. In step 106, the low-frequency signal is received by means of a second passive coupler in the control unit. In step 107, the low-frequency signal is demodulated by means of an envelope detector. In step 108, the demodulated signal is compared with at least one reference value by means of a threshold circuit in order to obtain a comparison result. In step 109, a control signal is output according to the comparison result. The method 100 ends in step 113.

In step 104, the first signal is converted in particular into a low-frequency signal within a carrier frequency range that differs from a frequency range for transmitting image data from an image sensor of the camera head. In addition, the low-frequency signal is in particular designed to be sinusoidal.

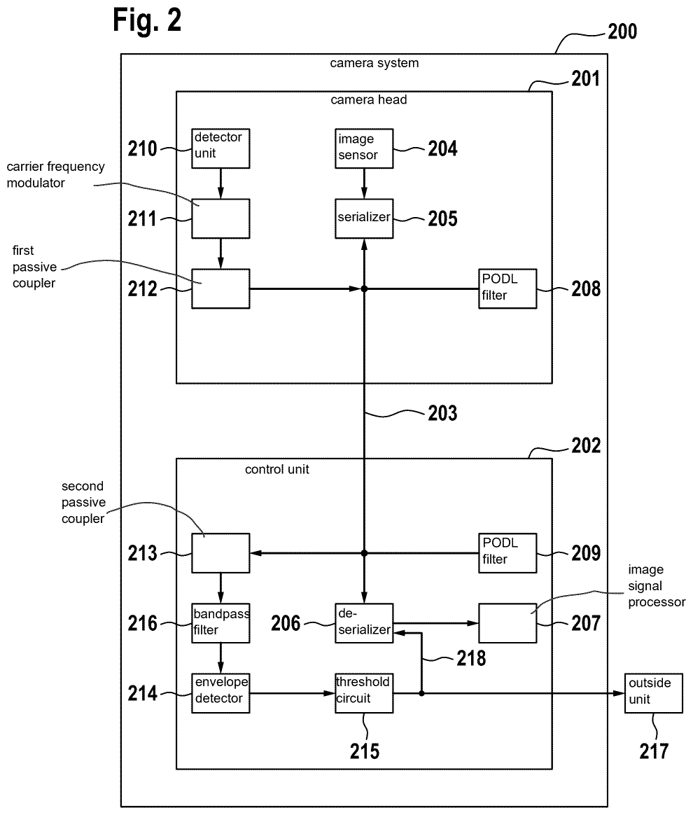

The method 100 can comprise the further step 110, which takes place after step 106. In step 110, the received low-frequency signal is filtered by means of a bandpass filter (FIGS. 2, 216).

The method 100 can comprise the further step 111, which takes place after the output 109 of the control signal. In step 111, an image sensor of the camera head is controlled in order to put the image sensor into an activated or deactivated state according to the comparison result.

The method 100 can comprise the further step 112, which takes place after the output 109 of the control signal. In step 112, a unit is controlled which is designed to change at least one physical parameter of the camera head.

A coupling factor for the transmission of the low-frequency signal from the camera head to the control unit is in particular selected to be so low that the output control signal can still be detected, but at the same time the high-frequency channel is not unnecessarily disturbed during operation.

The method 100 can be carried out by a camera system, as shown by way of example in FIG. 2.

FIG. 2 shows an exemplary embodiment of a camera system 200, wherein the camera system 200 comprises the camera head 201 and a control unit 202, which are connected to one another by means of a high-frequency channel 203. Here, the camera head 201 and the control unit 202 are formed in different structural units. Here, the camera head 201 and the control unit 202 comprise various units that can be used to carry out a method as described by way of example in FIG. 1. The units required for this will be described below, after further components of the Camera system 200 have been presented.

As can be seen in FIG. 2, the camera head 201 in the example shown comprises an image sensor 204, which is designed to detect light incident from a surrounding area of the camera system 200 as image data. Furthermore, the camera head 201 comprises a serializer 205, which is designed to convert the image data into a serial data format and to transmit them to the control unit 202 via the high-frequency channel 203. Additionally, the camera head 201 can comprise a PODL filter 208. In the example shown here, the control unit 202 comprises a deserializer 206, which is designed to deserialize image data transmitted via the high-frequency channel 203 and to transmit them to an image signal processor 207 of the control unit 202. In addition, the control unit 202 can comprise a PODL filter 209.

Here, the PODL filters 209 and 208 can be designed to apply the image data to the high-frequency channel and decouple them again. The PODL filters 208 and 209 thus isolate, in particular, a DC and AC component of a voltage on the high-frequency channel 203 from one another. A direct coupling of an output of a detector unit 210 of the camera head 201, described below, to the high-frequency channel would not be possible. The first signal output by the detector unit 210 would represent a direct current and would thus be short-circuited in the DC supply. However, by converting the first signal by means of the carrier frequency modulator, as provided by the method 100, the first signal is shifted into a carrier frequency range in which the PODL filters 208 and 209 represent a high impedance. This enables a parallel transmission to a DC supply of the camera head 201.

The following describes the units of the camera head 201 and of the control unit 202, which can be used to carry out a method 100 as described, for example, in FIG. 1. Thus, the camera head 201 comprises a detector unit 210, which is designed to detect at least one physical parameter of the camera head 201 and to output it as a first signal. Furthermore, the camera head 201 comprises a carrier frequency modulator 211. This is designed to convert the first signal into a low-frequency signal. A first passive coupler 212 of the camera head 201 is designed to transmit the low-frequency signal to the control unit 202 via the high-frequency channel 203. The control unit 202 in turn comprises a second passive coupler 213, which is designed to receive the low-frequency signal. An envelope detector 214 of the control unit 203 is designed to demodulate the low-frequency signal. Furthermore, the control unit 203 comprises a threshold circuit 215, which is designed to compare the demodulated signal with at least one reference value and to obtain a comparison result and to output a control signal according to the comparison result. Here, the control signal can be transmitted into the high-frequency channel 203. For this purpose, it can be connected, for example, to an input on the deserializer 206, as indicated by the return arrow 218. Alternatively, the control signal can also be transmitted to a unit 217 outside the camera system 200.

1-10. (canceled)

11. A method for operating a camera system comprising a camera head and a control unit, which are connected to one another by a high-frequency channel, the method comprising the following steps:
detecting at least one physical parameter in the camera head and outputting the detected at least one physical parameter as a first signal using a detector unit;
converting the first signal into a low-frequency signal within a carrier frequency range using a carrier frequency modulator;
transmitting the low-frequency signal to the control unit using a first passive coupler via the high-frequency channel;
receiving the low-frequency signal using a second passive coupler in the control unit;
demodulating the low-frequency signal using an envelope detector;
comparing the demodulated signal with at least one reference value using a threshold circuit in order to obtain a comparison result; and
outputting a control signal according to the comparison result.

12. The method according to claim 11, wherein the carrier frequency range differs from a frequency range for transmitting image data from an image sensor of the camera head.

13. The method according to claim 11, wherein the low-frequency signal is sinusoidal.

14. The method according to claim 11, further comprising the following step:
filtering the received low-frequency signal using a bandpass filter.

15. The method according to claim 11, further comprising the following step:
controlling an image sensor of the camera head in order to put the image sensor into an activated or deactivated state according to the comparison result.

16. The method according to claim 11, further comprising the following step:
controlling a unit that is configured to change at least one physical parameter of the camera head.

17. The method according to claim 11, wherein the control signal is additionally output to a sensor unit outside the camera system.

18. A camera system, comprising:
a camera head and a control unit that are connected to one another by a high-frequency channel;
wherein the camera head includes:
a detector unit, which is configured to detect at least one physical parameter of the camera head and to output the detected at least one physical parameter as a first signal,
a carrier frequency modulator, which is configured to convert the first signal into a low-frequency signal, and
a first passive coupler, which is configured to transmit the low-frequency signal to the control unit via the high-frequency channel, and
wherein the control unit includes:
a second passive coupler, which is configured to receive the low-frequency signal,
an envelope detector, which is configured to demodulate the low-frequency signal, and
a threshold circuit, which is configured to compare the demodulated signal with at least one reference value, to obtain a comparison result and to output a control signal.

19. The camera system according to claim 18, wherein the first and/or the second passive coupler is: a directional coupler and/or a high-impedance resistive coupling and/or as a resistor.

20. The camera system according to claim 18, wherein the control unit further includes a bandpass filter.
